(19) United States
(12) Patent Application Publication
(10) Pub. No.: US 2023/0365106 A1
(43) Pub. Date: Nov. 16, 2023

(54) Lithium Battery Powered Trailer Brake Breakaway Control Device and System

(71) Applicant: The NOCO Company, Glenwillow, OH (US)

(72) Inventors: Derek Michael UNDERHILL, Tempe, AZ (US); James P. McBRIDE, Phoenix, AZ (US); James Richard STANFIELD, Glendale, AZ (US)

(21) Appl. No.: 18/246,762

(22) PCT Filed: Sep. 28, 2021
(86) PCT No.: PCT/US2021/052416

§ 371 Date: Mar. 27, 2023

Related U.S. Application Data
(60) Provisional application No. 63/084,923, filed on Sep. 29, 2020.

(51) Int. Cl. B60T 7/20; B60T 17/22; B60T 13/74; H02J 7/00

(52) U.S. Cl. CPC B60T 7/20; B60T 17/22; B60T 13/74; H02J 7/0013; H02J 7/0029

(57) ABSTRACT

Provided is a trailer breakaway device for use with a vehicle/trailer having a vehicle/trailer brake, a vehicle/trailer electrical power supply, and a vehicle/trailer electrical ground, the trailer breakaway device including one or more rechargeable lithium battery cells; a battery management system (BMS) connected to the one or more rechargeable lithium battery cells; a charger connect to the vehicle/trailer power supply, the charger configured to receive power from the vehicle/trailer power supply; a current limiter connected to the one or more rechargeable lithium battery cells; and a breakaway switch connected to the current limiter.

### CROSS-REFERENCE TO RELATED APPLICATIONS

This application is a is a National Stage Entry of International Patent Application No. PCT/US2021/052416, filed on Sep. 28, 2021, which claims the benefit of priority to U.S. Provisional Application No. 63/084,923, filed on Sep. 29, 2020, each of which is hereby incorporated by reference in its entirety for all purposes.

### FIELD

The present invention is directed to a lithium (e.g. lithium ion) battery powered trailer brake breakaway control device and system, for example, including battery condition testing and trailer lighting alert.

### BACKGROUND

For years trailer brake breakaway systems have been made using lead acid batteries as the power source. A problem occurs when the lead acid battery sulfates and loses capacity without the user being aware. This results in the product no longer meeting minimum Department of Transportation (DOT) requirements for operation.

Information shown below is the minimum DOT requirements:
1. Single axle trailer (two 12 inch brake drums): 8.2 A maximum brake current
2. Double axle trailer (four 12 inch brake drums): 16.3 A maximum brake current

The battery capacity required to meet the 15 minute DOT requirement is calculated below:
1. Single axle trailer: (8.2 A)(0.25 hrs)=2.05 amp hours (Ah)
2. Double axle trailer: (16.3 A)(0.25 hrs)=4.1 amp hours (Ah)

### SUMMARY

The present invention is directed to a lithium battery powered trailer breakaway device, system, and method. For example, the present invention is directed to a lithium battery with a built in Trailer Light Warning System to alert other drivers that a trailer has disconnected during use. Further, a lithium battery heating system is also provided to insure proper operation in cold weather.

The presently described subject matter is directed to an improved trailer breakaway device, system, and method.

The presently described subject matter is directed to an improved lithium battery powered trailer breakaway device, system, and method.

The presently described subject matter is directed to a lithium battery powered electric brake trailer breakaway device, system, and method with trailer lighting alert function.

The presently described subject matter is directed to a lithium battery powered electric brake trailer breakaway device, system, and method with built in battery warming function.

The presently described subject matter is directed to a lithium battery powered electric brake trailer breakaway device, system, and method with built in battery management system.

The presently described subject matter is directed to a lithium battery powered electric brake trailer breakaway device, system, and method with a built in battery fuel gauge.

The presently described subject matter is directed to a lithium battery powered electric brake trailer breakaway device, system, and method with built in waterproofing.

The presently described subject matter is directed to a lithium battery powered electric brake trailer breakaway device, system, and method with a built in pull switch.

The presently described subject matter is directed to a lithium battery powered electric brake trailer breakaway device, system, and method with a coiled spring cable for the pull switch.

The presently described subject matter is directed to a lithium battery powered electric brake trailer breakaway device, system, and method with a built in charge indicator showing the user when the system is charging.

### BRIEF DESCRIPTION OF DRAWINGS

FIG. 1 is a perspective view of a lithium battery powered trailer brake breakaway control device according to the present invention.

FIG. 2 is a top view of the lithium battery powered trailer brake breakaway control device shown in FIG. 1.

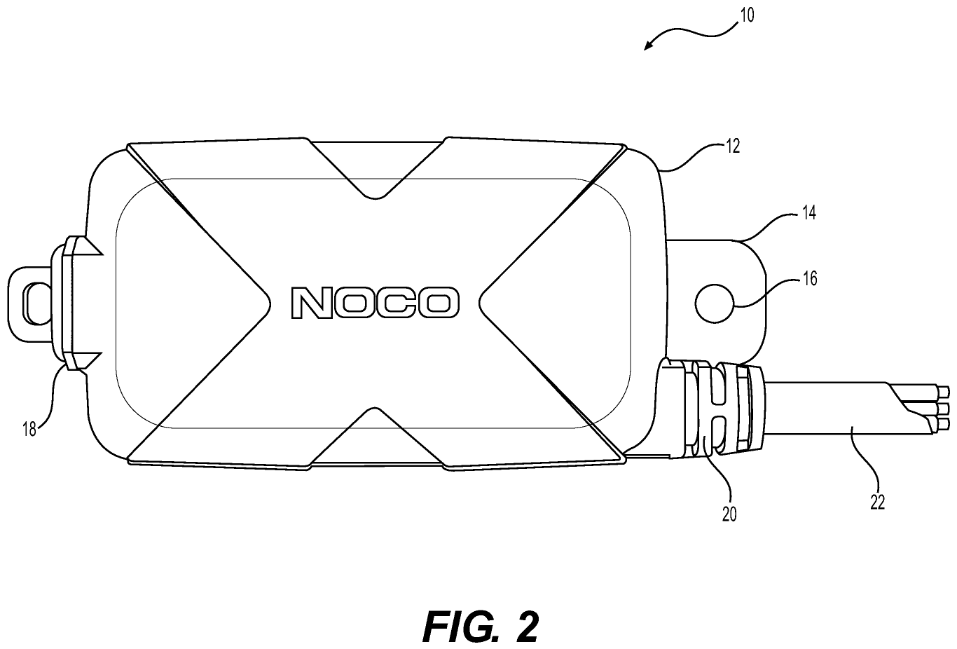

FIG. 3 is a trailer breakaway block diagram.

FIG. 4 is a trailer breakaway table showing specifications or requirements for various axle trailer configurations.

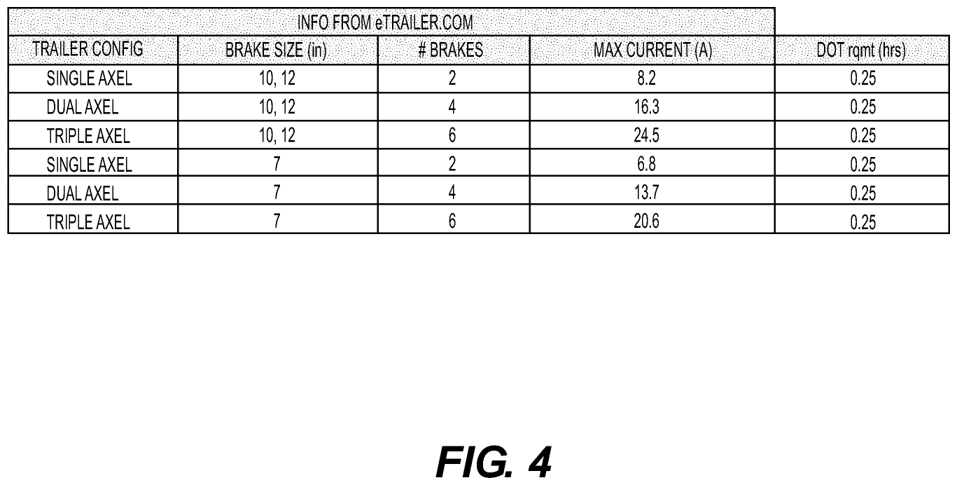

FIG. 5 is a graph showing cell discharge curves.

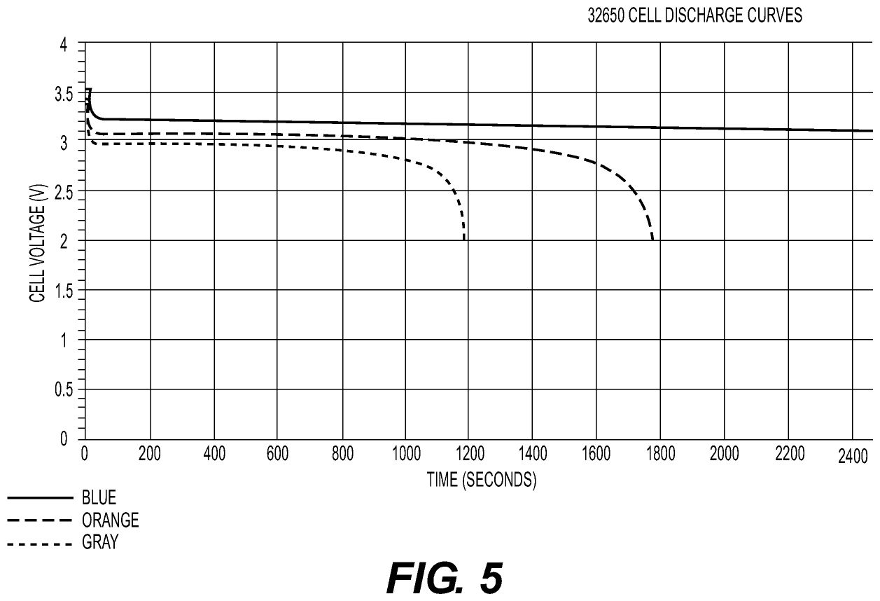

FIG. 6 is a graph showing cell discharge temperature curves.

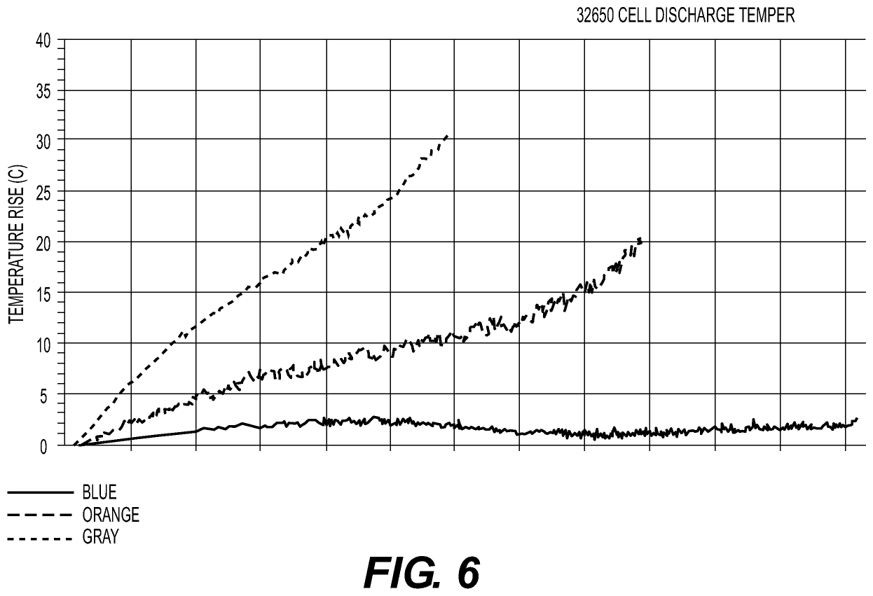

### DRAWING SCHEDULE

10 lithium battery powered trailer breakaway control device
12 housing
14 bracket
16 through hole (in bracket)
18 port cover
20 wire harness
22 flexible wire connector
24 lithium battery powered trailer breakaway control system
26 battery management system (BMS)
28 charger
30 current limiter
32 breakaway switch
34 rechargeable lithium battery cell
36 micro controller

### DETAILED DESCRIPTION

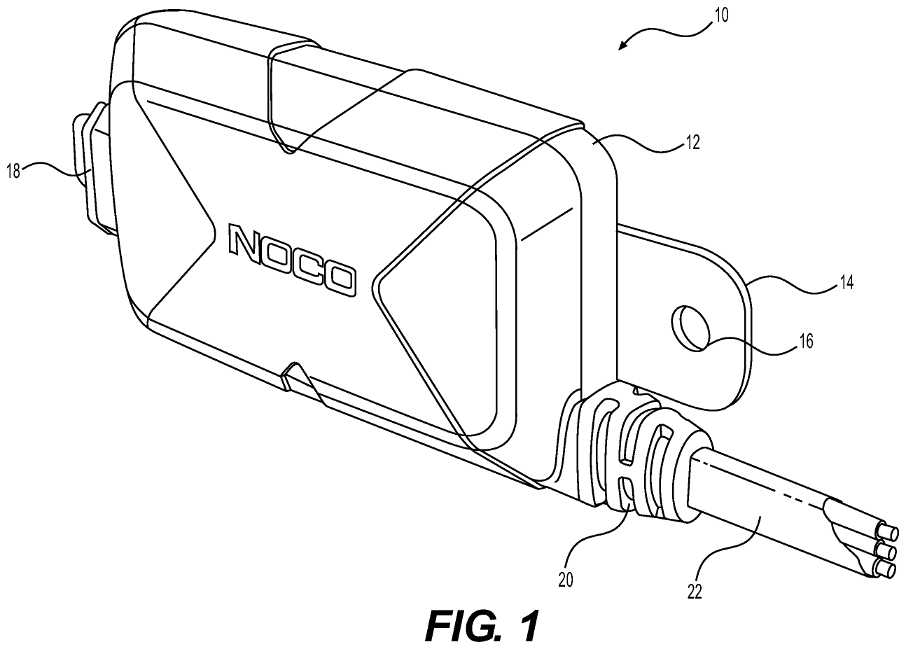

A lithium battery powered trailer brake breakaway control device 10 according to the present invention is shown in FIG. 1.

The lithium battery powered trailer brake breakaway control device 10 comprises a housing 12, a mounting bracket 14 having a through hole 16, a port cover 18, and a wire harness 20 connected to the housing 12 via a flexible wire connector 22.

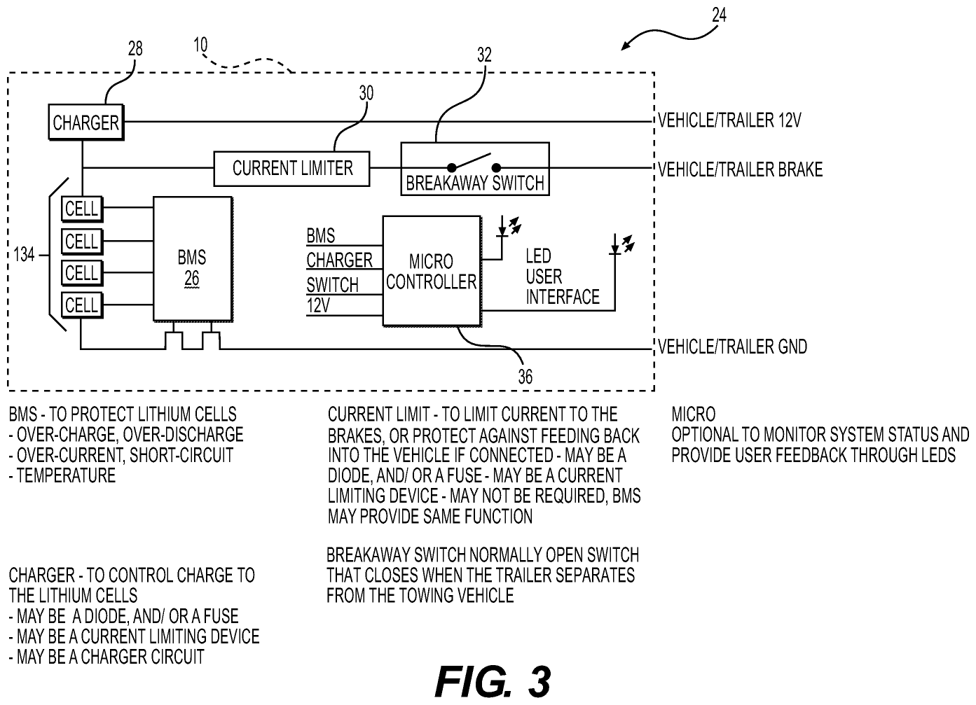

A lithium battery powered trailer breakaway control system 24 according to the present invention is shown in FIG. 3.

The control system 24 comprises a battery management system (BMS) 26, a charger 28, a current limiter 30, a breakaway switch 32, and rechargeable lithium battery cells 34. Optionally, a micro controller 36 can be added to the control system 24.

The battery management system (BMS) 26 is configured to protect the lithium cells 34 from over-charge, over-discharge, over-current, short-circuit, and temperature.

The charger 28 is configured to control charge to the rechargeable lithium battery cells 34. For example, the charger 28 comprises a diode, a fuse, a current limiting device, and/or a charger circuit.

The current limiter 30 is configured to limit current to the trailer brakes, or protect against current feeding back into the vehicle, if connected. For example, the current limiter 30 comprises a diode, a fuse, and/or a current limiting device. It is noted that the battery management system (BMS) 26 may provide some or all of these same functions.

The breakaway switch 32 is configured to normally be an open switch that closes when the trailer separates from a towing vehicle.

The optional micro controller 36 is configured to monitor system status and provide user feedback through light emitting diodes (LEDs).

The rechargeable lithium battery cells 34, for example, can be a Low Capacity LiFePO4 32650 Batteries. For example, four (4) LiFePO4 32650 batteries are used as the battery source.

In another example, the lithium cells 34 can be High Capacity LiFePO4 32650 Batteries. For example, eight (8) LiFePO4 32650 batteries are used as the battery source.

In a further example, the lithium cells 34 can be LiFePO4 18650 Batteries. For example, four (4) LiFePO4 18650 batteries are used as the battery source.

In an even further example, the lithium cells can be located in a LiFePO4 Pouch. For example, one (1) LiFePO4 pouch is used as the battery source.

The lithium cells 34 can be replaced with cells having different lithium battery chemistries. Various lithium chemistries could be used in this application, including but not limited to, LiFePO4, NMC, Lithium Manganese Oxide, Lithium Nickel cobalt aluminum oxide, Lithium titanate,

The device 10 and system 24 can have waterproofing. For example, the design supports waterproofing all electronics including the battery pack.

The device 10 and system 24 can include a Light Warning System. For example, the design will support flashing the trailer lights in a warning pattern to alert other drivers that there is a problem with the trailer after a breakaway has occurred.

1. A trailer breakaway device for use with a vehicle trailer having a vehicle trailer brake, a vehicle trailer electrical power supply, and a vehicle trailer electrical ground, the trailer breakaway device comprising:
one or more rechargeable lithium battery cells;
a battery management system (BMS) connected to the one or more rechargeable lithium battery cells, the battery management system (BMS) configured to manage and control the one or more rechargeable lithium battery cells;
a charger connected to the vehicle trailer power supply, the charger configured to receive power from the vehicle trailer power supply, the charger connected to the one or more rechargeable lithium battery cells, the charger configured to charge the one or more rechargeable lithium battery cells;
a current limiter connected to the one or more rechargeable lithium battery cells, the current limiter configured to receive electrical power from the one or more rechargeable lithium battery cells; and
a breakaway switch connected to the current limiter, the breakaway switch configured to receive electrical power from the current limiter.

2. The device according to claim 1, wherein the one or more lithium battery cells is multiple lithium battery cells.

3. The device according to claim 1, further comprising a micro controller connected to one or more of the battery management system (BMS), the charger, a 12V switch, or a 12V power supply.

4. The device according to claim 1, wherein the battery management system (BMS) is configured to protect the one or more lithium battery cells from at least one from the group consisting of over-charging, over-discharging, over-current, short-circuit, and temperature.

5. The device according to claim 1, wherein the charger is configured to control charging of the one or more lithium battery cells.

6. The device according to claim 6, wherein the charger comprises one or more selected from the group consisting of a diode, fuse, current limiting device, and a charging circuit.

7. The device according to claim 1, wherein the current limiter is configured to limit current to the vehicle trailer brakes.

8. The device according to 7, wherein the current limiter comprises one or more selected from the group consisting of diode, fuse, and current limiting device.

9. The device according to claim 1, wherein the breakaway switch is configured to normally be open, and closes when a trailer separates from a towing vehicle of the vehicle trailer.

10. The device according to claim 3, wherein the micro controller is configured to monitor system status and provide user feedback through light emitting diodes (LEDs).

11. A trailer breakaway system, comprising the trailer breakaway device according to claim 1.

12. The system according to claim 11, further comprising the vehicle trailer having the vehicle trailer brake, the vehicle trailer electrical power supply, and the vehicle trailer electrical ground.
